(19) United States
(12) Patent Application Publication
(10) Pub. No.: US 2012/0293366 A1
(43) Pub. Date: Nov. 22, 2012

(54) SYSTEM, METHOD AND COMPUTER PROGRAM FOR ULTRA FAST TIME TO FIRST FIX FOR A GNSS RECEIVER

(75) Inventors: Zhe Liu, Calgary (CA); Francis Yuen, Calgary (CA)

(73) Assignee: BASEBAND TECHNOLOGIES INC., Calgary, AB (CA)

(21) Appl. No.: 13/575,512

(22) PCT Filed: Jan. 27, 2011
(86) PCT No.: PCT/CA11/00087

§ 371 Date: Jul. 26, 2012

Related U.S. Application Data
(60) Provisional application No. 61/298,681, filed on Jan. 27, 2010.
(60) Provisional application No. 61/298,634, filed on Jan. 27, 2010.
(60) Provisional application No. 61/298,650, filed on Jan. 27, 2010.

(51) Int. Cl. G01S 19/43

(52) U.S. Cl. 342/357.26

(57) ABSTRACT

The present invention provides a system, method and computer program for a GNSS receiver that is operable to provide an ultra fast Time To First Fix (TTFF). The invention is implementable without requiring the decoding of a navigation message transmitted by GNSS satellite systems. The system of the present invention may comprise a parameter obtaining means, a clock obtaining means and a Fast TTFF engine. The parameter obtaining means may obtain satellite parameters of one or more GNSS satellites. The clock obtaining means may obtain a clock for estimating a GNSS time tag. The Fast TTFF engine may be linkable to a signal interface that is operable to provide I/Q samples from a GNSS antenna. The Fast TTFF engine may comprise a measurement generation utility, a coarse search utility and a fine search utility. The measurement generation utility may compute the Doppler frequency shift and the code phase of the one or more GNSS satellites based on the I/Q samples.

### CROSS-REFERENCE TO RELATED APPLICATIONS

This application claims the benefit of U.S. Provisional Application No. 61/298,634 filed Jan. 27, 2010, U.S. Provisional Application No. 61/298,650 filed Jan. 27, 2010, and U.S. Provisional Application No. 61/298,681 filed Jan. 27, 2010, the entirety of which are incorporated herein by reference.

### FIELD OF THE INVENTION

The present invention relates to GNSS receivers. The present invention more specifically relates to a GNSS receiver is operable to provide an ultra fast Time To First Fix (TTFF).

### BACKGROUND TO THE INVENTION

Global navigation satellite systems (GNSS) techniques are used to provide reliable positioning, navigation and timing services to worldwide users on a continuous all weather, all day and all terrain basis. GNSS receivers acquire, process and decode space-based navigation signals to determine the receiver position. GNSS includes Global Positioning System (GPS) of the United States, the GLONASS system of Russia, the GALILEO system of European Union, the BEIDOU/COMPASS system of China and any other similar satellite systems.

The following description discusses using a radio frequency circuitry (RF circuitry) to provide In-phase/Quadrature (I/Q) samples with In-phase component, or Quadrature component, or both. However, it should be understood that RF circuitry shall include, but not limited to (i) RF Front-end, (ii) radio frequency integrated circuit (RFIC) or (iii) anything that can provide I/Q samples.

Traditional GPS receivers comprise a RF circuitry and a dedicated baseband processor to acquire, extract, down-convert and demodulate GPS signals for position determination. Traditional GPS receivers normally determine positions by computing times of arrival of the signals transmitted from not-less-than 4 GPS satellites. Each satellite transmits a navigation message that includes its own ephemeris data as well as satellite clock parameters.

TTFF is a specification detailing the time required for a GNSS receiver to acquire satellite signals and calculate a position solution (called a fix). Generally, GNSS receivers with the shortest TTFF are preferred. The TTFF of a GNSS receiver is affected by the individual hardware and software design of the GNSS receiver.

Traditional GPS receivers acquire, track and decode GPS navigation message in real-time. The navigation message includes information such as almanac/ephemeris parameters, a highly accurate time tag, satellite clock corrections, atmospheric models/corrections as well as other information that is necessary for position determination by a receiver.

The purpose of acquisition is to identify all satellites visible to the receiver. If a satellite is visible to the receiver, the receiver must determine its frequency and code phase. The code phase denotes the point in the current data block where the coarse acquisition (C/A) code begins. The C/A code is a pseudo-random sequence that repeats itself once every millisecond. The code phase can also be treated as the residual of the pseudorange measurement modulated by 1 ms, or the pseudorange measurements with an unknown integer number of milliseconds bias.

In order for traditional receivers to compute the receiver position, it requires real-time navigation message data. When the signal is properly tracked, the C/A code and the carrier wave are removed, leaving only the navigation message data bits. One GPS navigation message frame lasts for 30 seconds, hence, it will take no less than 30 s to obtain a complete GPS navigation message frame.

With a decoded navigation message, traditional GPS receivers can determine the GPS time tag by using the Z-count to align the locally-generated signals with the received signals.

Subsequently, using the time tag, or the Z-count, embedded in the navigation message, the exact time of when the navigation message was transmitted from the satellite can be determined. Once the navigation message is decoded, the ephemeris data (used later to compute the position of the satellite at the time of transmission), or the almanac data, for the satellite will be available. Other useful information such as Ionospheric correction parameters for single-frequency users and satellite clock corrections parameters can also be decoded for later use. Finally, pseudoranges are computed based on the time difference between the satellite transmitted time and the receiver received time.

Disadvantages of hardware-based GPS receiver include: (i) component and manufacturing costs; (ii) difficult to upgrade; (iii) constantly consume power; and (iv) requires valuable real estate on PCB etc.

Additionally, assuming the satellite signal is strong, the process of searching for and acquiring GPS signals, reading the ephemeris data for multiple satellites and computing the location of the receiver from this data is time consuming and often requires from 60 s to 12.5 minutes for “Cold Start”. When the conventional technique is used to determine a position, the time tag must be determined from the decoded navigation message to determine the pseudoranges. Until the time tag is determined, the measured pseudorange is ambiguous. Under certain operating environments (such as forests or urban canyons) where the signal is blocked intermittently and/or the signal is weak, it is difficult or often impossible for standard GPS receivers to maintain lock and decode the navigation message to determine the time tag. As a result, positioning solutions cannot be computed. In many cases, this lengthy processing time makes it impractical or unsuitable for certain applications.

Assisted GPS (AGPS) technology has been proposed to solve this problem. It is typically used for cellular devices that are capable of downloading from a cellular network some of the data required for GPS position determination. However, an AGPS receiver needs to be connected to the AGPS network in order to operate. As such, the receiver cannot be operated autonomously. AGPS also cannot avoid the necessity of decoding the time mark, requires accurate and surveyed coordinates for each cellular tower; and still exhibits a TTFF of many seconds.

Meanwhile, software based GPS receivers have been developed as an evolutionary step in the development of modern GNSS receivers. Instead of using a dedicated baseband processor, software-based GNSS receiver technologies (also known as Software-Defined Radio or SDR) employ only the RF circuitry to extract, down-convert, demodulate and process the GPS signals using software on a general purpose processor such as a central processing unit (CPU) or digital signal processor (DSP). The idea is to position the processor as close to an antenna as is convenient, transfer received I/Q samples into a programmable element and apply digital signal processing techniques to calculate the receiver position. Software based GNSS receivers are an attractive solution since they can be easily scaled to accept and utilize advances in GPS protocols. For example, in the near future some GNSS protocols will have a number of additional signals that can be utilized for positioning, navigation, and timing. Typically, software receivers only need software upgrade to allow for the inclusion of the new signal processing, while users of ASIC-based receivers will have to purchase new hardware components to access these new signals. Other benefits of software based GPS receivers include rapid development time, cost efficiency and notable flexibility.

However, the problem with the traditional software-GPS receiver processing methodology is that it requires a significant amount of I/Q samples transferred to the processor to compute a receiver position. Due to the intense data processing, traditional software-based GPS receiver methodology significantly increases the CPU loads which, in turn, rapidly deplete the battery life of a portable device. As a result, traditional software-based GPS receiver methodology is typically not suitable for modern miniaturized portable electronics.

Moreover, the traditional software-GPS receiver also requires real-time navigation message data to obtain the accurate time tag and compute the receiver position. Thus the TTFF is still lengthy and makes it impractical or unsuitable for certain applications.

U.S. Pat. No. 7,133,772 to Global Locate Inc. discloses a system and method to determine a position of a GPS receiver instantaneously with both Doppler Frequency Shift measurements and Code Phase measurements. Global Locate Inc. requires a wireless connection to obtain the ephemeris data and an accurate time tag from a wireless communication system. As such, the system cannot be operated autonomously.

U.S. Pat. No. 5,798,732 to Trimble Navigation Limited discloses a system and method for a GPS receiver to have a fast time to first fix (TTFF) by using Doppler Frequency Shift measurements to correct the local clock time. The invention includes a Doppler correction code for improving the accuracy of the local time by comparing a measured and a calculated Doppler Frequency Shift for the GPS satellite signal. However, Trimble Navigation Limited requires the approximate user position and user velocity.

There is a need, therefore, to provide a software or hardware implementable GNSS receiver system that is operable to provide a fast TTFF autonomously without the need for decoding a navigation message, approximate position and velocity, and without the need for significant processing power and expensive hardware.

### SUMMARY

The present disclosure relates to a system, method and computer program for a GNSS receiver that is operable to provide an ultra fast Time To First Fix (TTFF).

The present disclosure also describes a system for determining position of a global navigation satellite system (GNSS) receiver having a fast time to first fix, the system comprising: (a) a parameter obtaining means for obtaining satellite parameters of one or more GNSS satellites; (b) a clock obtaining means for obtaining a clock for estimating a GNSS time tag; and (c) a Fast TTFF engine linkable to a signal interface that is operable to provide I/Q samples with In-phase component, or Quadrature component, or both from a GNSS antenna. The Fast TTFF engine comprising: (i) a measurement generation utility to compute the Doppler frequency shift and the code phase of the one or more GNSS satellites based on the I/Q samples; (ii) a coarse search utility to determine a coarse position based on Doppler frequency shift measurements, the satellite parameters, and the time tag; and (iii) a fine search utility to determine position based on the coarse position, BPSR measurements, the satellite parameters, and the time tag.

The present invention provides a system, method and computer program for a GNSS receiver that is operable to provide an ultra fast Time To First Fix (TTFF). The invention is implementable without requiring the decoding of a navigation message transmitted by GNSS satellite systems. The system of the present invention may comprise a parameter obtaining means, a clock obtaining means and a Fast TTFF engine. The parameter obtaining means may obtain satellite parameters of one or more GNSS satellites. The clock obtaining means may obtain a clock for estimating a GNSS time tag. The Fast TTFF engine may be linkable to a signal interface that is operable to provide I/Q samples from a GNSS antenna. The Fast TTFF engine may comprise a measurement generation utility, a coarse search utility and a fine search utility. The measurement generation utility may compute the Doppler frequency shift and the code phase of the one or more GNSS satellites based on the I/Q samples.

The coarse search utility may determine a coarse position based on Doppler frequency shift measurements, the satellite parameters, and the time tag. The fine search utility may determine position based on the coarse position, BPSR measurements, the satellite parameters, and the time tag.

The coarse search utility may refine the time tag by estimating values of a time tag error variable and a clock drift error variable to model the error between the clock and the time tag and compensating the time tag error and the clock drift error using one or more iterations of a least squares algorithm. Similarly, the fine search utility may refine the time tag by estimating values of a time tag error variable and a receiver clock bias variable to model the error between the clock and the time tag and compensating the time tag error and the receiver clock bias using one or more iterations of a least squares algorithm. The time tag error variable may be estimated using a non-linear function, wherein the derivative of the non-linear function over the time tag error variable is available or obtainable.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 illustrates a system in accordance with an embodiment.

FIG. 2 illustrates the hardware architecture of an embodiment.

FIG. 3 illustrates a method for obtaining Doppler Frequency Shift Measurements and BPSR Measurements.

FIG. 4 illustrates a method for obtaining fast TTFF in accordance with an embodiment.

FIG. 5 illustrates how the Coarse Search Utility may determine PVT in accordance with an embodiment.

FIG. 6 illustrates how PVT may be computed based on the Doppler Frequency Shift Measurements in accordance with an embodiment.

FIG. 7 illustrates how the Fine Search Utility may determine position in accordance with an embodiment.

FIG. 8 illustrates how position may be computed based on the BPSR Measurements in accordance with an embodiment.

### DETAILED DESCRIPTION

The present invention provides a system, method and computer program for a GNSS receiver that is operable to provide an ultra fast Time To First Fix (TTFF). The invention is implementable without requiring the decoding of a navigation message transmitted by GNSS satellite systems.

### 1. Overview

TTFF represents the time delay from the time the GNSS receiver is powered up to the time that the first valid position is computed. Typically a position is deemed as “valid” when its accuracy meets the requirement, which may be user defined or be specified by standards. A Fast TTFF engine, a clock obtaining means and a parameter obtaining means are provided for acquiring satellite signals and calculating a position solution, typically at meter-level accuracy, with as little as 2 ms of data, thus it is possible to obtain a valid position typically within just a few milliseconds. The Fast TTFF engine processes I/Q samples collected by a typical RF circuitry and, based on an estimated time tag and obtained satellite parameters, computes position. Due to simple hardware design and optimized techniques, the overall power consumption of the Fast TTFF engine, the clock obtaining means and parameter obtaining means is extremely low or, in some cases, negligible and is therefore implementable to common commercially available GNSS receiver designs.

The system of the present invention may comprise a parameter obtaining means, a clock obtaining means and a Fast TTFF engine. The parameter obtaining means may obtain satellite parameters of one or more GNSS satellites. The clock obtaining means may obtain a clock for estimating a GNSS time tag. The Fast TTFF engine may be linkable to a signal interface that is operable to provide I/Q samples from a GNSS antenna. The Fast TTFF engine may comprise a measurement generation utility, a coarse search utility and a fine search utility. The measurement generation utility may compute the Doppler frequency shift and the code phase of the one or more GNSS satellites based on the I/Q samples. The coarse search utility may determine a coarse position based on Doppler frequency shift measurements, the satellite parameters, and the time tag. The fine search utility may determine position based on the coarse position, BPSR measurements, the satellite parameters, and the time tag. The coarse search utility may refine the time tag by estimating values of a time tag error variable and a clock drift error variable to model the error between the clock and the time tag and compensating the time tag error and the clock drift error using one or more iterations of a least squares algorithm. Similarly, the fine search utility may refine the time tag by estimating values of a time tag error variable and a receiver clock bias variable to model the error between the clock and the time tag and compensating the time tag error and the receiver clock bias using one or more iterations of a least squares algorithm. The time tag error variable may be estimated using a non-linear function, wherein the derivative of the non-linear function over the time tag error variable is available or obtainable.

The following description discusses the implementation of the invention for GPS. However, it should be understood that the present invention is readily implementable to other GNSS systems such as the GLONASS system of Russia, the GALILEO system of European Union, the BEIDOU/COMPASS system of China, and positioning systems which utilize pseudolites or a combination of satellites and pseudolites, and any other similar systems in which a plurality of satellites, and/or pseudolites, and/or other type of transmitters, have known accurate reference frequencies. By definition, pseudolites are ground-based transmitters which broadcast a PRN code (similar to a GPS signal) modulated on an L-band carrier signal, generally synchronized with GPS time.

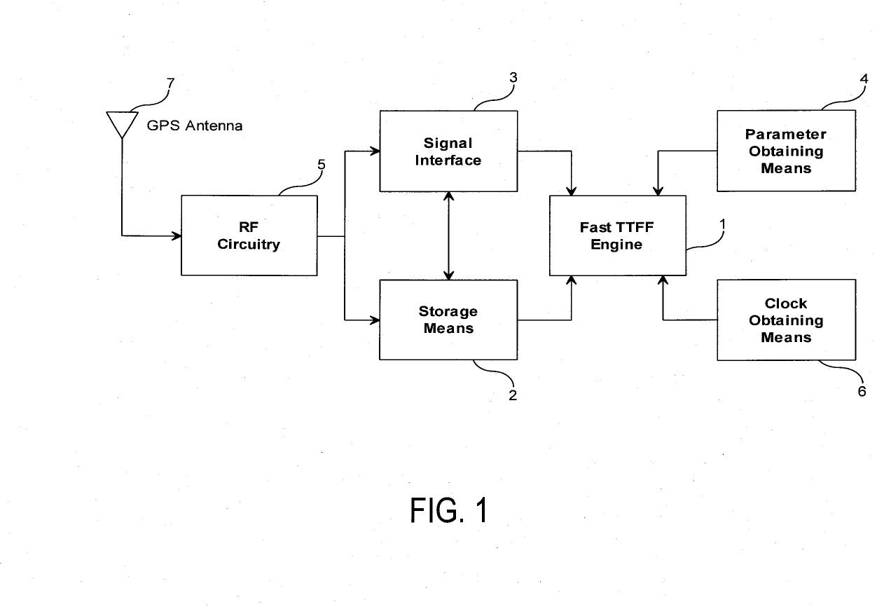

FIG. 1 illustrates a system in accordance with the present invention. The system may comprise a Fast TTFF engine 1 linkable to a signal interface 3 and/or to a storage means 2, which may be further linked to RF circuitry 5 and GPS antenna 7. The RF circuitry may be operable to provide down-converting, signal conditioning/filtering, automatic gain controlling and analog-to-digital converting of the analog GPS satellite signals to I/Q samples. The signal interface 3, which may for example be a USB interface, may transmit I/Q samples to the Fast TTFF engine. The Fast TTFF engine may receive I/Q samples from the RF circuitry via the signal interface and/or the storage means. I/Q samples may also be passed between the signal interface and the storage means. In addition, the parameter obtaining means 4 may provide the Fast TTFF engine with satellite parameters, for example by download or predictive techniques, including ephemeris or almanac parameters. The clock obtaining means 6 may provide the Fast TTFF engine with a clock for estimating a time tag.

The system may also be implemented as a distributed computing system, for example comprising a client device linked by network to a server device wherein the server device may provide processing functionality. If the position is processed at the server device, very little bandwidth may be required between the client device and server device as the Fast TTFF engine requires very few I/Q samples.

The Fast TTFF engine may comprise (i) a Measurement Generation Utility (ii) a Coarse Search Utility and (iii) a Fine Search Utility. The accuracy of the position generated by the Coarse Search Utility and the Fine Search Utility will be assessed. The Fast TTFF engine will end once the accuracy of the position meets the specified requirements of TTFF's position accuracy.

The Measurement Generation Utility may generate raw measurements that include both the Doppler Frequency Shift and the Code Phase measurements with as little as 2 ms of I/Q samples. The Doppler Effect causes the frequency of a given satellite to change from its nominal value, and the Doppler Frequency Shift is an index of the change on the frequency. A coarse acquisition (C/A) code is a pseudo-random sequence, and repeats itself once every millisecond. The Code Phase denotes the point in the current data block where the C/A code begins. This way the Code Phase can also be treated as the residual of the pseudorange measurement modulated by 1 ms, or the pseudorange measurements with an unknown integer number of milliseconds bias. The Code Phase measurement is also referred to as “Biased Pseudorange” or “BPSR” herein, since BPSR can be treated as the Pseudorange added with a bias, which is opposite to the integer milliseconds of the travel time.

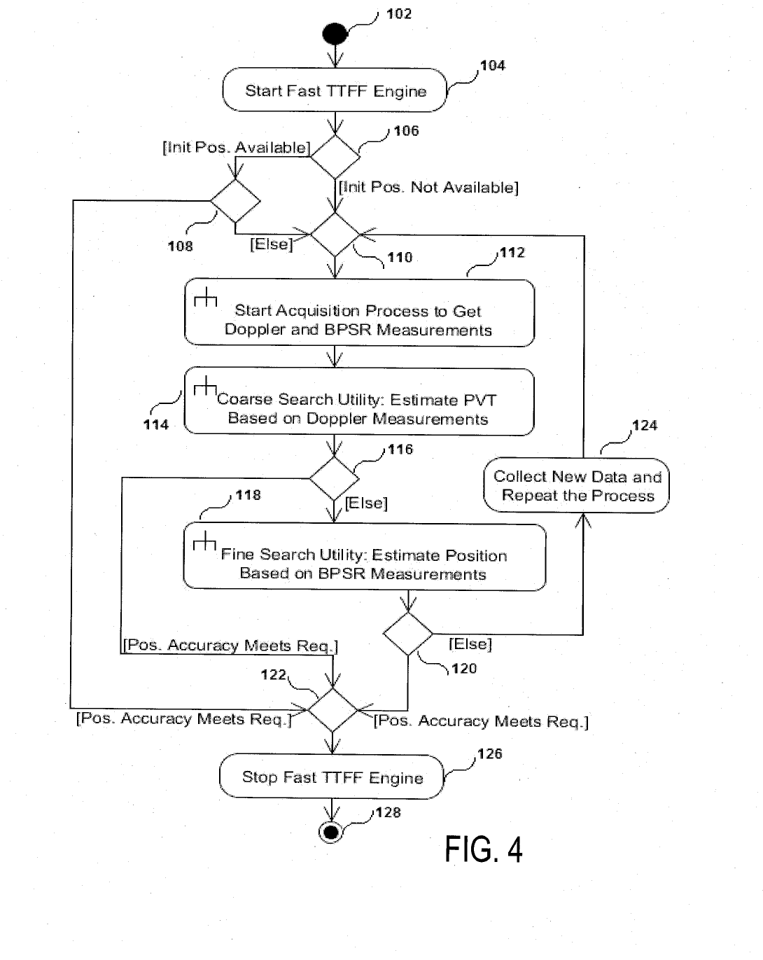

FIG. 4 illustrates a method for obtaining fast TTFF in accordance with the present invention. The Fast TTFF engine, or the engine for short, begins at the Startup-Point 102. At Decision 106, if the initial receiver position is available, its accuracy will be assessed at Decision 108. If its accuracy has already met the requirement of TTFF, the Fast TTFF engine may end as shown at 126, since TTFF is already available and there is no need to go further. If its accuracy does not meet the requirement of TTFF, or its accuracy may not be assessed, or the initial receiver position is not available, as shown at Merge 110, the engine will start the Acquisition process to get the Doppler and BPSR measurements, as shown at action 112. The “rake” symbol, which represents a hierarchy, indicates action 112 can be expanded into a diagram. After the measurements are available, the engine will call the Coarse Search Utility to estimate PVT based on the Doppler measurements, as shown at action 114. Once PVT is available, its accuracy will be assessed at Decision 116. If its accuracy has already met the requirement of TTFF, the Fast TTFF engine may end as shown at 126. For all other cases, the engine will call the Fine Search Utility to estimate position based on the BPSR measurements, as shown at action 118. Once again, the position accuracy will be assessed at Decision 120. If its accuracy has already met the requirement of TTFF, the Fast TTFF engine may end as shown at 126. For all other cases, the engine will discard the current collected I/Q data, collect new data, and restart the process, as shown at 124. The new data will be passed to action 112 for processing via Merge 110, and the process goes on until the position accuracy meets the TTFF requirement. Once the position accuracy meets the TTFF requirement, the engine will stop and exit at the End-Point 128.

The Fast TTFF engine may operate in real time or near real time or may be further linked to a storage means which could, for example, enable a post-processing mode for static, low-dynamic and high-dynamic applications. It should be noted that the Fast TTFF engine does not require “always-on” access as required by AGPS.

The I/Q samples may be obtained from: (a) a tracking loop of any GNSS satellite signal receiver (hardware or software based); (b) a GNSS RFIC; (c) a GNSS RF front-end; (d) direct RF sampling using an analogue-to-digital converter (ADC); or (e) any other means by which to obtain the I/Q samples.

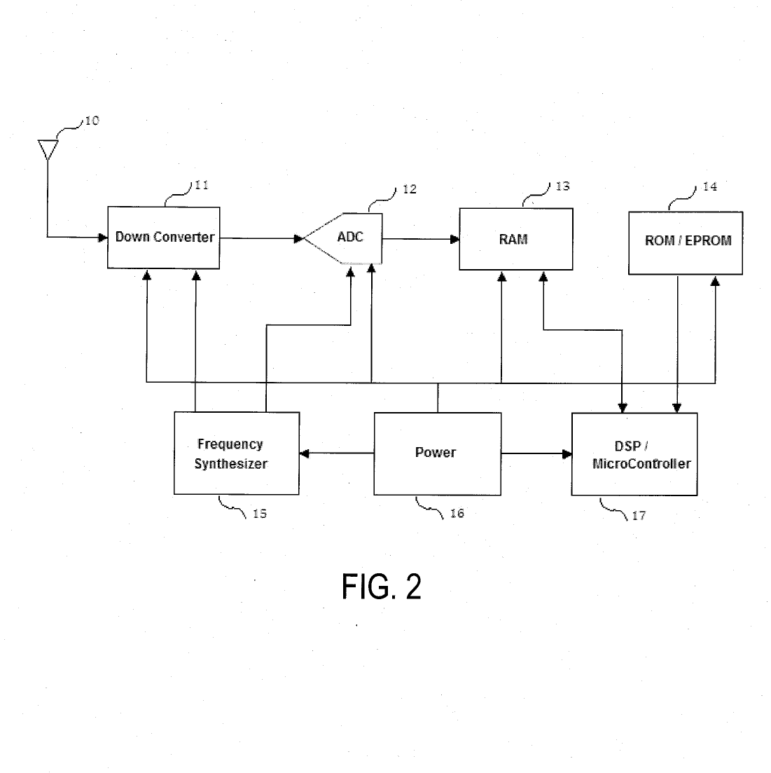

FIG. 2 is a block diagram of the hardware architecture of one embodiment of the invention. The system may comprise a GPS antenna 10 linkable to a signal down-converter 11 which converts the RF signals to IF band. The signals are passed to an ADC (Analog-to-Digital Converter) 12, and then saved to RAM/memory 13 coupled to a MicroController or DSP 17 for processing to get PVT solutions. The firmware, which includes the algorithm for processing, is stored at non-volatile memory such as ROM/EPROM 14. A Frequency Synthesizer 15 provides the clock and synchronization mechanism for the system, and a Power subsystem 16, which may include a battery pack or an AC adapter, supplies power to the system.

### 2. Measurement Generation Utility

The Measurement Generation Utility may provide any of several means for obtaining Doppler Frequency Shift measurements based on sampled data. For example, Parallel Frequency Space Search Acquisition may be provided. Parallel Frequency Space Search Acquisition utilizes Fourier transform to perform transformation from time domain to frequency domain. If the locally generated code is well aligned with the code in the incoming signal, the output from Parallel Frequency Space Search may have a peak at the nominal center frequency plus Doppler Frequency Shift.

The Measurement Generation Utility may provide any of several means for obtaining BPSR (Code Phase) measurements based on sampled data. For example, Parallel Code Phase Search Acquisition may be provided. Instead of multiplying the input signal with a PRN code with shifted code phases, Parallel Code Phase Search Acquisition makes a circular cross correlation between the input and the PRN code without shifted code phase to improve the search efficiency. If the locally generated code is well aligned with the code in the incoming signal, the output from Parallel Code Phase Search Acquisition may have a peak, and the index of this peak marks the PRN code phase of the incoming signal.

The Doppler Frequency Shift and BPSR measurements can also be obtained in other ways. For example, for a conventional receiver, the BPSR and the Doppler Frequency Shift measurements are typically available once the tracking loops are locked. These measurements can be used in accordance with the present invention.

The sampled data should optimally not be collected during the transition of navigation data bits. The navigation data is transmitted at 50 bits per second, which translates to 20 ms for the length of each navigation data bit. In order to avoid sampled data collected during the transition, one option is to collect 1 ms of data first and then another 1 ms of data right after it with no time gap to guarantee at least one of the 1 ms data block is outside of a navigation data bit transition. Thus, for certain applications, it may be preferred to collect at least 2 sets of 1 ms samples each for determining the Doppler Frequency Shift measurements and BPSR measurements.

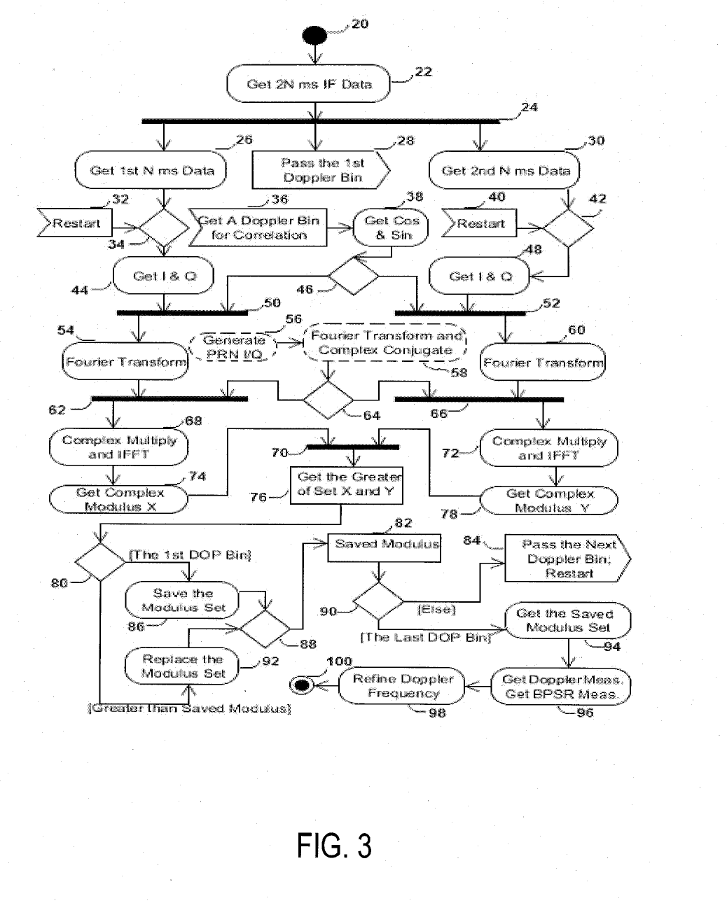

FIG. 3 illustrates an acquisition process to obtain Doppler Frequency Shift Measurements and BPSR measurements via an UML Activity Diagram. The acquisition process begins at the Start-Point 20, and may obtain 2*N ms of I/Q data from the signal interface 22, where N may be an integer no less than one. The 2*N ms data may be divided evenly into 2 equal sets of N ms each, 26 and 30. To support parallel processing, a Fork 24 for further processing may dispatch both 26 and 30, together with a signal of the first Doppler bin 28. 26 and 30 are converted into complex signals 44 and 48 via Merge 34 and 42 respectively, which reach Join 50 and 52 through Branch 46, and are ready for carrier removal. The signal 28 is received by node 36, and the first Doppler bin is converted into a complex signal 38, which represents the local carrier. The local carrier is sent to Join 50 and 52 to remove carrier from signals 44 and 48. However, it is worth to mention that other processing technique such as sequential processing will also be supported. After carrier removal, Fourier Transform 54 and 60 may be applied to the complex signals. For real-time applications, FFT (Fast Fourier Transform) and many other techniques are applied to reduce the CPU and memory usage and to speed up the process, while padding and other techniques are applied to meet the size requirement of FFT, and reduce the associated computation errors. Node 56 will generate N ms sampled C/A sequence of a chosen PRN matching the sampling rate of the signals, while node 58 will perform Fourier Transform and Complex Conjugate on the sampled C/A sequence. As a good practice, the sampled C/A sequence may be computed in advance and saved in non-volatile memory, thus the sampled C/A sequence will be always available and does not require additional CPU and memory for computation at run time. The dotted boundary of node 56 and node 58 indicate that these nodes may not be performed at run time. When both the sampled C/A sequence and FFT-converted complex signals become available at Branch 64, they will be processed with Complex Multiply and IFFT (Inversed Fast Fourier Transform) operations, shown at 68 and 72 through Join 62 and 66 respectively, to generate two Complex Modulus sets X and Y, shown at 74 and 78. When both set X and set Y are ready at Join 70, the Acquisition Margin of set X will be compared with the Acquisition Margin of set Y at node 76, and the set with the greater Acquisition Margin will be kept while the other set will be discarded. Acquisition Margin is defined as the ratio of the largest to next largest correlation. At Decision 80, if the current Doppler Bin in effect is the first Doppler Bin, the kept set will be saved and it is the first saved set, as shown at 86. If the current Doppler Bin in effect is not the first Doppler Bin, so it will not be the first saved set and it will be compared with a previously saved set, whichever set has the greater Acquisition Margin will be kept together with their associated Doppler Bin index, as shown at 92, and the other will be thrown away. The saved set 82 from Merge 88 will be passed to a Decision 90. If the current Doppler Bin in effect is not the last Doppler Bin that should be tested, two signals will be dispatched: test the next Doppler Bin as the first signal, and Restart as the second, as shown at 84. The first signal will be received by node 36, while the second signal will be received by node 32 and node 40. The process will cycle until the last Doppler Bin arrives at Decision 90, then the saved set together with its associated Doppler Bin will be retrieved, as shown at 94. The index of the saved Doppler Bin generates the coarse Doppler measurements, while the location of the maximum (peak) of the saved set determines the BPSR measurements, as shown at 96. The coarse Doppler measurements may be refined, typically by Parallel Frequency Space Search, to achieve the fine Doppler measurements, or Doppler Frequency Shift, as shown at 98. Once the Doppler measurements and BPSR measurements become available, acquisition process reaches the End-Point 100.

It should be noted that the probability of detecting highly accurate Doppler Frequency Shift and BP SR Measurements for certain satellites increases with the amount of data, since redundancy of observations usually lead to more accurate and reliable results. Thus, the Doppler Frequency Shift and BPSR Measurements may be refined from sample to sample.

The acquisition process may be configurable to acquire from 2 ms to any amount of I/Q samples. The I/Q samples may comprise I, Q, or I and Q data in any combination of bit resolutions. Regardless of whether 2 ms or greater than 2 ms of samples are collected, the Fast TTFF engine may provide TTFF much faster than in the prior art. Once the RFIC collects and the signal interface sends to the acquisition process with sufficient amounts of I/Q samples, the acquisition process may compute the Doppler Frequency Shift and BPSR Measurements immediately or store the I/Q samples to non-volatile memory for post-processing.

### 3. Source of Almanac/Ephemeris and Other Parameters

As previously mentioned, a traditional GPS receiver requires about 30 seconds to acquire the ephemeris by receiving and decoding a navigation message. The Fast TTFF engine only needs to collect as little as 1 ms, and it does not to decode the navigation message. Parameters normally decoded from the navigation message may be obtained from other sources. These parameters include: almanac/ephemeris parameters; satellite clock corrections; atmospheric models/corrections; and other information necessary or desirable for position determination. For example, precise almanac/ephemeris (satellite orbit and clock parameters) are available as free downloads at public sources such as IGS and NGS web sites. Alternatively, predictive satellite almanac/ephemeris algorithms may be provided to enable autonomous receiver operation. Alternatively, satellite positions and clock errors can also be determined by the almanac. Atmospheric corrections can also be downloaded at public sources such as IGS and NGS web sites or can be modeled by other means.

Since an accurate time tag may not be obtained without decoding the navigation message, the Fast TTFF engine generates an accurate time tag by estimating and compensating the time tag error. Thus there is no need for the Fast TTFF engine to receive and decode the navigation message. The Fast TTFF engine may use a snap-shot of I/Q samples to search for signals and process only when needed. The Fast TTFF engine does not require a tracking stage as in the prior art. Therefore, no tracking loop is required to compute the receiver position. Instead, the receiver position may be determined based directly on the Doppler Frequency Shift and BPSR

### 4. Clock Related Errors Estimation & Compensation

Typically, very accurate time reference requires expensive and bulky hardware such as an atomic clock. In contrast, devices such as mass-produced crystal oscillators, which are more convenient due to small size, cost and low power requirements, are relatively inaccurate. Moreover, the clock drift error caused by inaccurate time reference such as that from a low-cost oscillator directly affects the measured Doppler Frequency Shift value.

The time tag error consists of two components: common time tag error and relative time-tag error. The common time tag error, also called the receiver clock bias, is defined as the offset of the Real Time Clock (RTC) from the GPS Time (GPST). The relative time-tag error is mostly determined by the geometry of the satellites related to the receiver. The time derivative of the receiver clock bias, which is defined as the clock drift error, affects Doppler positioning greatly. The relative time tag error also plays a significant role in Doppler positioning. Hereinafter, the time derivative of the common time tag error will be referred to as the clock drift error; the relative time tag error will be referred to as the time tag error.

The Fast TTFF engine may be provided with a clock from the clock obtaining means. The clock may, for example, be a real-time clock or user supplied date. The clock may be used as an inaccurate initial time tag. The PVT engine may begin computation using the inaccurate initial time tag and introduce variables to represent the time tag error, the receiver clock bias, and the clock drift error. The error variables can be estimated and then used to correct the initial time tag and update the receiver clock bias and the clock drift error. The correction may be provided by a least squares algorithm. An iterative refinement may be used as samples are collected to refine the time tag and the receiver clock bias. This enables the satellite orbit determination (positioning), which is a non-linear function of the time tag, to be determined. The clock drift error may be accurately estimated and used by the Coarse Search Utility, while the receiver clock bias will be accurately estimated and used by the Fine Search Utility.

### 5. Coarse Search Utility

The Coarse Search Utility may generate a coarse receiver position and coarse satellite positions based on the Doppler Frequency Shift measurements provided by the Measurement Generation Utility, a rough time tag from the clock obtaining means, and the available Ephemeris or Almanac. If the accuracy of the coarse receiver position already meets the specified requirements of TTFF's position accuracy, the Fast TTFF engine may report success and stop. Otherwise, the coarse pseudoranges may be generated based on the coarse receiver position and the coarse satellite positions, and be passed to the Fine Search Utility.

5.1 PVT Determination with Doppler Observables

The Coarse Search Utility may calculate PVT based on the Doppler Frequency Shift value generated by the acquisition process. The Coarse Search Utility may provide a weighted least squares technique to assign proper weight for each Doppler Frequency Shift to further improve the accuracy of PVT determination. In practice, if the receiver dynamic is either static or low dynamic, the PVT engine may discard the velocities from the estimation. The accuracy of a coarse position may be in the order of 100 kilometres or better, and it has the potential to reach much higher accuracy.

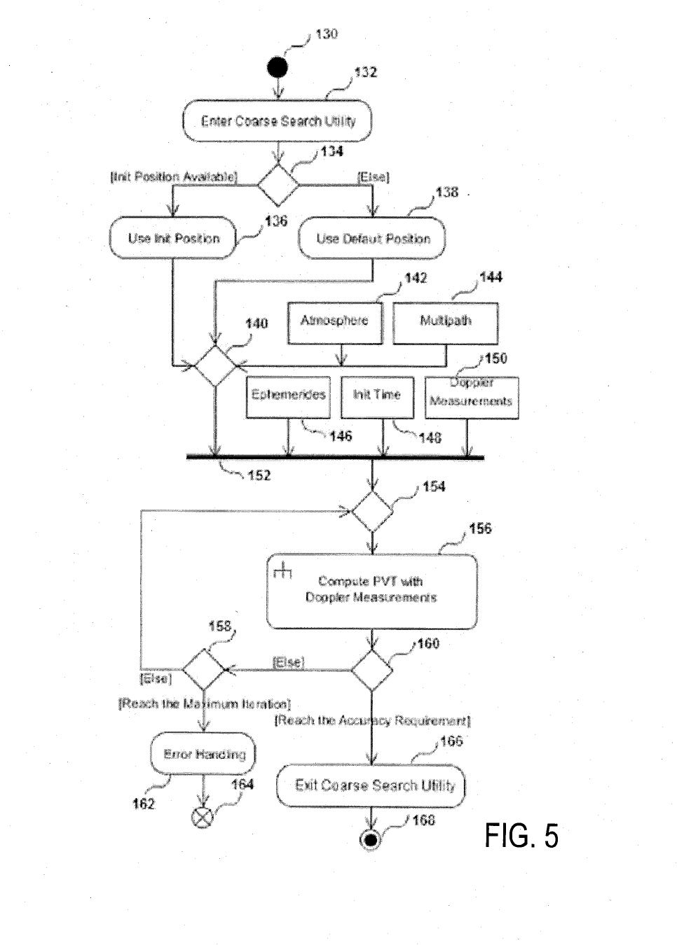

FIG. 5 illustrates how Fast TTFF engine determines PVT in accordance with the present invention. The Fast TTFF engine, or the engine for short, begins at the Start-Point 130, and enters the Coarse Search Utility 132. The engine may determine whether an initial receiver PVT is known at Decision 134. The initial receiver PVT may be provided by the user, or may come from a recently used or generated receiver PVT, or by a default value. If initial receiver PVT is already known, it will be used as shown at 136. If initial receiver PVT is not known, a default receiver PVT 138 may be used instead of the initial receiver PVT 136. The default receiver PVT may be set to a recently used or generated receiver PVT. As an example, if there is no prior knowledge about the receiver position, the default receiver position may be set to the center of the Earth, or any position on or in the Earth. In other word, the engine has virtually no requirement toward the initial receiver position. However, a relatively accurate initial receiver position or PVT usually helps the engine converge faster and more accurate. The initial receiver PVT may be replaced with the calculated receiver PVT of the engine, which is expected to have a better accuracy, by the engine at the end. The Atmosphere component 142, which includes the Ionospheric and tropospheric models and parameters, together with the Multipath component 144, which include the Multipath model and parameters, may be optionally added to the flow with the initial receiver PVT at Merge 140. Other than 142 and 144, the engine requires ephemerides 146, initial time 148, and Doppler measurements 150. Only when all of them are available at Join 152, together with the flow, which includes the initial receiver position, the engine starts the algorithm to compute the receiver PVT, as shown at action 156. The “rake” symbol, which represents a hierarchy, indicates action 156 can be expanded into a diagram. If the PVT accuracy already meets the requirements, as shown at Decision 160, the engine will exit the Coarse Search Utility 166 and exit the engine at the End-Point 168. If the PVT accuracy does not meet the requirements yet, the engine will decide if another iteration should be performed to improve the accuracy, as shown at Decision 158. If the number of iteration has already reached the regulated maximum, no more iteration will be performed, and the engine will display and handle the error 162 then exit 164. If the number of iteration has not reached the regulated maximum yet, another iteration will be carried out, and action 156 will be executed so the engine will go on.

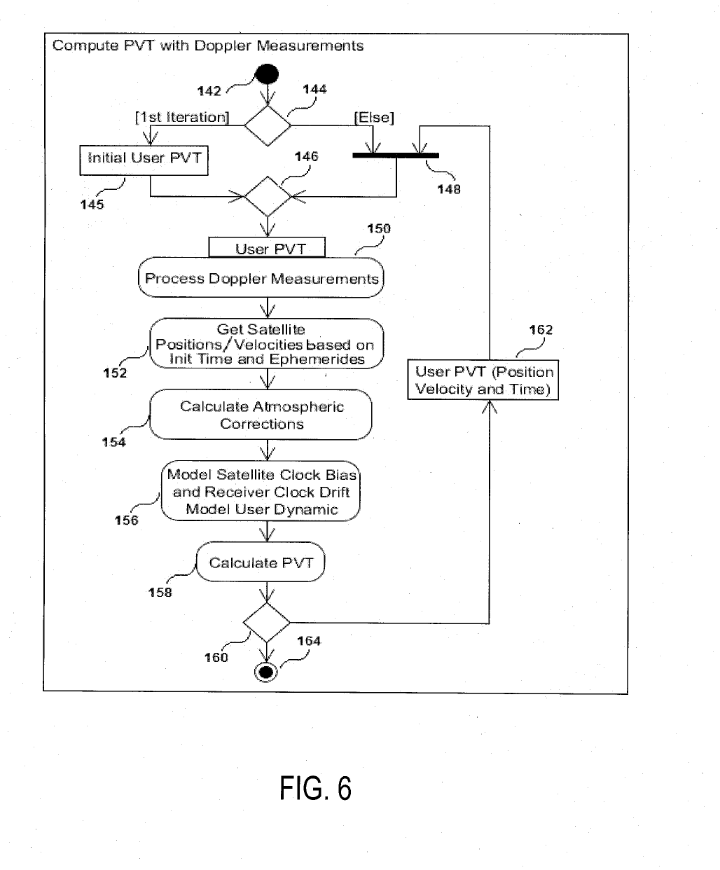

Action 156 can be expanded into another an UML activity diagram, as illustrated in FIG. 6. The process begins at the Start-Point 170, and enters the Decision 172. For the first iteration, it will use the initial user PVT, as shown as Object 174, and move into the Merge 178, then starts to process the Doppler measurements together with the receiver PVT as shown at 180. As shown at 182, the satellite positions and velocities, which are important for the following modelling, may be computed based on the initial time and ephemerides. The next step is to calculate atmospheric corrections 184. The next step is to model Satellite Clock Bias and Receiver Clock Drift 186, and calculate PVT 188. The user velocities may be modelled as well if either the user is neither static nor low dynamic, or the number of Doppler measurements is abundant, say no less than 8. Otherwise in practice the user velocities can be ignored from the modelling. Once PVT is calculated, the process will reach the End-Point 194, so the engine that called the sub-process may go on. At the same time, the intermediate User Position, Velocity, and Time 192 will be sent to Join 176, and wait for the next call of the action 156 to arrive. Once 156 is called again, it will take the intermediate User Position, Velocity, and Time 192 as user PVT, and then starts to process the Doppler measurements together with the user PVT as shown at 180, and the process goes on.

Doppler Effect is caused by a transmitter that is in relative motion with respect to a receiver. When the transmitter approaches the receiver, the transmitted signal is squeezed. This produces an increase in the frequency of the transmitted signal. When a transmitter moves away from the receiver, the transmitted signal is stretched, producing a decrease in the frequency of the transmitted signal. The benefit of the Doppler-based positioning approach is that the Doppler measurements can be received even when the standard GPS positioning fails. Doppler measurements can be used to solve the receiver position without the navigation message but this requires the knowledge of satellite orbital parameters and a time tag, which as previously mentioned may be derived from the RTC.

The Doppler Frequency Shift of the i^{th} satellite can be modeled with the dot product equation:

$${D}_{i} = - ( \frac{{V}_{i} - {V}_{u}}{c} \cdot \frac{{r}_{i} - {r}_{u}}{‖ {r}_{i} - {r}_{u} ‖} ) * {f}_{L 1} \qquad ( 1 )$$

where Dᵢ is the Doppler frequency of the i^{th} satellite, Vᵢ is the velocity of the i^{th} satellite, Vᵤ is the velocity of the receiver, c is the speed of light, rᵢ is the location of i^{th} satellite, rᵤ is the location of the receiver and f_{L1} is the frequency transmitted by the satellite.

The present invention enables the Doppler measurements to be made by using the real-time clock even where it exhibits significant error relative to an atomic time or satellite time. The time derivative of the receiver clock bias (or the clock drift error) may be denoted by \dot{t}ᵤ. Clock drift error refers to several related phenomena where a clock does not run at nominal speed. If \dot{t}ᵤ is positive, the receiver clock is running faster than its nominal speed and if \dot{t}ᵤ is negative, it is running slower than its nominal speed. The error Δf in the estimate for the received frequency can be modeled as:

Δf=−\dot{t}ᵤ*f_{L1} (2)

Clock drift error may directly affect the measured Doppler Frequency Shift value. Since the GPS control segment ensures each GPS satellite operates at very close to the nominal L1 frequency and adds correction terms to the navigation messages when necessary, the error in the transmitted frequency may cause little harm for the receiver. By contrast, the oscillator/clock at the receiver side typically causes error in estimating the Doppler Frequency Shift of the received signal accurately, and it is not generally constant in time.

Doppler Frequency Shift measurements may be generated by subtracting the actual frequency from the nominal frequency of any given satellite or by other means.

The Doppler Frequency Shift measurements of the i^{th} satellite can be represented as

Dᵢ=dᵢ−Δf+ε=dᵢ+\dot{t}ᵤ*f_{L1}ε (3)

where dᵢ is the Doppler Frequency Shift measured by the receiver during the acquisition process, which includes the Doppler Frequency Shift of the i^{th} satellite. The Doppler Frequency Shift Dᵢ of the i^{th} satellite is then simply the sum of dᵢ, the opposite of the clock error Δf and the measurement noise ε.

From (1) and (3), the following equation can be derived:

$${d}_{i} + ɛ = - ( \frac{{V}_{i} - {V}_{u}}{c} \cdot \frac{{r}_{i} - {r}_{u}}{‖ {r}_{i} - {r}_{u} ‖} ) * {f}_{L 1} - {\dot{t}}_{u} * {f}_{L 1} \\ {d}_{i} + ɛ = - ( \frac{{V}_{i} - {V}_{u}}{c} \cdot \frac{{r}_{i} - {r}_{u}}{‖ {r}_{i} - {r}_{u} ‖} ) * {f}_{L 1} + {t}_{u}^{′} * {f}_{L 1} \qquad ( 4 )$$

The velocity and location of the satellite may be calculated based on the time tag and satellite orbital parameters. Since the initial time tag is usually inaccurate and will result in an error, the derived velocity and location of the satellite will be inaccurate and have an error also. The error can be represented as a non-linear function of the time tag error eₜ. The function may be different for every satellite since their ephemeris/almanac parameters may be different. After considering the time tag error, (4) will become:

$${d}_{i} + ɛ = - ( \frac{{V}_{i} - {V}_{u}}{c} \cdot \frac{{r}_{i} - {r}_{u}}{‖ {r}_{i} - {r}_{u} ‖} ) * {f}_{L 1} - {\dot{t}}_{u} * {f}_{L 1} + S ( {e}_{t} , i ) \qquad ( 5 )$$

where S(eₜ,i) is a non-linear function of the time tag error eₜ for each satellite.

An assumption may be made that the measurement noises is white-noise or white-noise like. For the left side of (5), they may be known observables. For the right side of (5), both c and f_{L1} may be known constants. Since the approximate GPS transmit time may be known, assuming S(eₜ, i), and Vᵢ and rᵢ may also be treated as known values. Thus Vᵤ, rᵤ, \dot{t}ₜ₁ and eₜ may be included into the states for estimation. Assuming there are more than 8 qualified Doppler Frequency Shift measurements and a roughly-known time tag for all the measurements, then when combining with known almanac and/or ephemeris parameters, the receiver position (X/Y/Z, or Latitude/Longitude/Height), the receiver velocity (Vₓ, V_{y}, V_{Z}), the clock drift error \dot{t}ᵤ and the error of the initial time tag eₜ can be determined. For static or low dynamic positioning, it may be acceptable to approximate Vᵤ to zero or white noise for simplification. If X represents the states, the right side of (5) can be represented as a function of X as follows:

$${G}_{i} ( X ) = - ( \frac{{V}_{i} - {V}_{u}}{c} \cdot \frac{{r}_{i} - {r}_{u}}{‖ {r}_{i} - {r}_{u} ‖} ) * {f}_{L 1} - {\dot{t}}_{u} * {f}_{L 1} + S ( {e}_{t} , i ) \\ G ( X ) = [ \begin{matrix}{G}_{1} ( X ) \\ {G}_{2} ( X ) \\ ⋮\end{matrix} ] \qquad ( 6 )$$

Since (6) is a non-linear equation, a Taylor series can be used to approximate it around X₀ as follows:

G(X)≈G(X₀)+G′(X|X₀)*dXG(X)≈G(X₀)+G′(X|X₀)*dX (7)

Assuming S(eₜ, i), its derivatives over eₜ, or its simplified linear form over eₜ may be available, for example, by numerical analysis, G′(X|X₀) will be derivable. Thus (5) may be written as a standard linear least-square equation:

$$y = [ \begin{matrix}{y}_{1} \\ {y}_{2} \\ ⋮\end{matrix} ] = Ax \\ y = Ax \qquad ( 8 )$$

with:

yᵢ=dᵢ−Gᵢ(X₀)y=dᵢ−G(X₀) (9)

A=G′(X|X₀)A=G′(X|X₀) (10)

x=dX=X−X₀x=dX (11)

Furthermore, the quality of the Doppler Frequency Shift measurements may be affected by factors such as the geometry of the satellites and their movements, atmosphere activities, interferences, multipath and the receiver hardware. In turn, the quality of the Doppler Frequency Shift measurements may affect the performance of the Coarse Search Utility and the accuracy of the PVT solutions. By introducing noisy observables into the weighted least square algorithm without assigning proper weights to them the accuracy of the solutions may degrade.

The Coarse Search Utility may assess the quality of the Doppler Frequency Shift measurements and assign them proper weights. The Coarse Search Utility may assign weights to the Doppler Frequency Shift measurements using the variance-covariance matrix R of the measurement noise.

If the variance-covariance matrix R of measurement noise is unknown, the estimation of x, which represents the delta value of the estimated states X, can be represented as:

\hat{x}=(A^{T}*A)⁻¹*A^{T}*y\hat{x}=(A^{T}*A)⁻¹*A^{T}*y (12)

If the variance-covariance matrix R of measurement noise is available, according to the definition of the Best Linear Unbiased Estimator (BLUE), the estimation of x can be represented as:

\hat{x}=(A^{T}*R⁻¹*A)⁻¹*A^{T}*R⁻¹*y\hat{x}=(A^{T}*R⁻¹*A)⁻¹*A^{T}*R⁻¹*y (13)

The accuracy of a PVT calculation may be in the order of 100 kilometres or better, for both low and high dynamic applications. The estimation and compensation for the time tag error may loose the initial time requirement up to a few tens of minutes. Such a loose requirement on the initial time accuracy may enable the RF circuitry to continue to work for years without calibration or alignment on their clock.

5.2 Using Doppler Measurements of Multiple Epochs

There may be cases when the number of the Doppler Frequency Shift measurements is less than the number of system variables/states to be estimated. The Coarse Search Utility may use measurements from adjacent epochs to generate valid PVT solutions. For example, the Doppler measurements of the current epoch can be used together with the Doppler measurements of one or more of the past epochs to constitute observations and equations and solve the states. Since independent Doppler Frequency Shift measurements may be obtained almost every 1 ms, the time tag difference between measurements are typically no more than 1 or 2 ms. Therefore, it can be assumed that the variables of the system X, Y, Z, Vₓ, V_{y}, V_{z}, \dot{t}ᵤ, and eₜ which represent receiver position, velocity, clock drift error and the time tag error are virtually unchanged during this short period. However, since satellites can move several meters within 1 ms, the satellite position may be measured by its own time tag.

For example, if i is the Doppler Frequency Shift measurement at epoch t₁, and j is the Doppler Frequency Shift measurement at epoch t₂, then equation (6) can be rewritten as:

$$\begin{matrix}{G}_{i , {t}_{1}} ( X ) = - ( \frac{{V}_{i} {\vert}_{{t}_{1}} - {V}_{u} {\vert}_{{t}_{1}}}{c} \cdot \frac{{r}_{i} {\vert}_{{t}_{1}} - {r}_{u} {\vert}_{{t}_{1}}}{‖ {r}_{i} {\vert}_{{t}_{1}} - {r}_{u} {\vert}_{{t}_{1}} ‖} ) * {f}_{L 1} - {\dot{t}}_{u} {\vert}_{{t}_{1}} * {f}_{L 1} + S ( {e}_{t} {\vert}_{{t}_{1} , i} ) & ( 14 ) \\ {G}_{j , {t}_{2}} ( X ) = - ( \frac{{V}_{j} {\vert}_{{t}_{2}} - {V}_{u} {\vert}_{{t}_{2}}}{c} \cdot \frac{{r}_{j} {\vert}_{{t}_{2}} - {r}_{u} {\vert}_{{t}_{2}}}{‖ {r}_{j} {\vert}_{{t}_{2}} - {r}_{u} {\vert}_{{t}_{2}} ‖} ) * {f}_{L 1} - {\dot{t}}_{u} {\vert}_{{t}_{2}} * {f}_{L 1} + S ( {e}_{t} {\vert}_{{t}_{2}} , j ) & ( 15 )\end{matrix}$$

Equations (14) and (15) can represent either the same satellite (i=j) or two different satellites (i≠j).

Assuming the receiver position, the receiver velocity, the clock drift error, and the time tag error of t₁ are virtually the same as those of t₂, (16) can be derived from (14) and (15).

$${G}_{ij , {t}_{12}} ( X ) = - ( \frac{{V}_{i} {\vert}_{{t}_{1}} - {V}_{u}}{c} \cdot \frac{{r}_{i} {\vert}_{{t}_{1}} - {r}_{u}}{‖ {r}_{i} {\vert}_{{t}_{1}} - {r}_{u} ‖} ) * {f}_{L 1} + ( \frac{{V}_{j} {\vert}_{{t}_{2}} - {V}_{u}}{c} \cdot \frac{{r}_{j} {\vert}_{{t}_{2}} - {r}_{u}}{‖ {r}_{j} {\vert}_{{t}_{2}} - {r}_{u} ‖} ) * {f}_{L 1} + S ( {e}_{t} {\vert}_{{t}_{1}} , i ) - S ( {e}_{t} {\vert}_{{t}_{2}} , j ) \qquad ( 16 )$$

Now rᵤ, vᵤ, and eₜ may be the states to be estimated based on (16). Alternatively, rᵤ, vᵤ, \dot{t}ᵤ and eₜ can be estimated based on (14) and (15). As long as the assumptions of (i) the difference of the receiver position between t₁ and t₂; (ii) the difference of the receiver velocity between t₁ and t₂; (iii) the difference of the receiver clock drift error between t₁ and t₂; and (iv) the difference of the time tag error between t₁ and t₂ are valid; the observables can be increased by introducing more Doppler Frequency Shift measurements at different epochs. Thus the states may be estimated.

### 6. Fine Search Utility

The Fine Search Utility may generate a fine receiver position by using the coarse pseudoranges based on the coarse receiver position and the coarse satellite positions provided by the Coarse Search Utility. The coarse pseudoranges may then be used to determine the integer millisecond part of the pseudoranges. Finally the integer millisecond part of the pseudoranges and the BPSR measurements may be used to construct the pseudoranges. If the accuracy of the coarse pseudoranges is insufficient to determine the integer millisecond part of the pseudoranges uniquely, several candidates of the integer millisecond part of the pseudoranges may be checked and the one with the least residuals may be chosen as the most accurate solution.

6.1 Position Determination with BPSR Observables

The Fine Search Utility may calculate the receiver position based on the BPSR measurements generated by the acquisition process, along with either the uniquely determined integer milliseconds part of the travel time, or several candidates. The methods to determine the integer milliseconds part of the travel time have been mentioned above. The Fine Search Utility may provide a weighted least squares technique to assign proper weight for each BPSR measurement to further improve the accuracy of position determination. The position accuracy may be in the order of meters to tens of meters, and it has the potential to reach much higher accuracy.

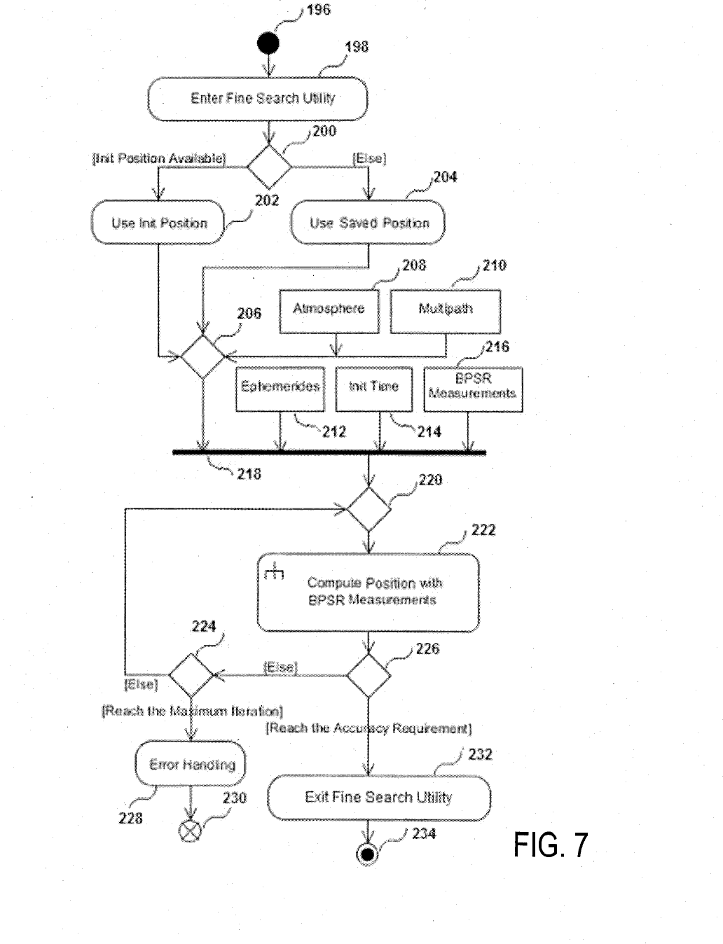

FIG. 7 illustrates how the Fast TTFF engine determines the receiver position in accordance with the present invention. The Fast TTFF engine, or the engine for short, begins at the Start-Point 196, and enters the Fine Search Utility 198. The engine may determine whether an initial receiver position is known at Decision 200. If initial receiver position is already known, it will be used as shown at 202. If initial receiver position is not known, a default receiver position 204 may be used instead of the initial receiver position 202. The default receiver position may be set to a recently used or generated receiver position. Typically, as a general rule, if the accuracy of the initial receiver position or the default receiver position that will be used is better than 100 km, the engine will converge and generate a valid receiver position. Otherwise the engine may not converge, or may generate invalid receiver positions that usually have large standard deviations. On the other hand, a relatively accurate initial receiver position usually helps the engine converge faster and more accurate. The initial receiver position may be replaced with the calculated receiver position of the engine, which is expected to have a better accuracy, by the engine at the end. The Atmosphere component 208, which includes the Ionospheric and tropospheric models and parameters, together with the Multipath component 210, which include the Multipath model and parameters, may be optionally added to the flow with the initial receiver position at Merge 206. Other than 208 and 210, the engine requires ephemerides 212, initial time 214, and BPSR measurements 216. Only when all of them are available at Join 218, together with the flow, which includes the initial receiver position, the engine starts the algorithm to compute the receiver position, as shown at action 222. The “rake” symbol, which represents a hierarchy, indicates action 222 can be expanded into a diagram. If the position accuracy already meets the requirements, as shown at Decision 226, the engine will exit the Fine Search Utility 232 and exit the engine at the End-Point 234. If the position accuracy does not meet the requirements yet, the engine will decide if another iteration should be performed to improve the accuracy, as shown at Decision 224. If the number of iteration has already reached the regulated maximum, no more iteration will be performed, and the engine will display and handle the error 228 then exit 230. If the number of iteration has not reached the regulated maximum yet, another iteration will be carried out, and action 222 will be executed so the engine will go on.

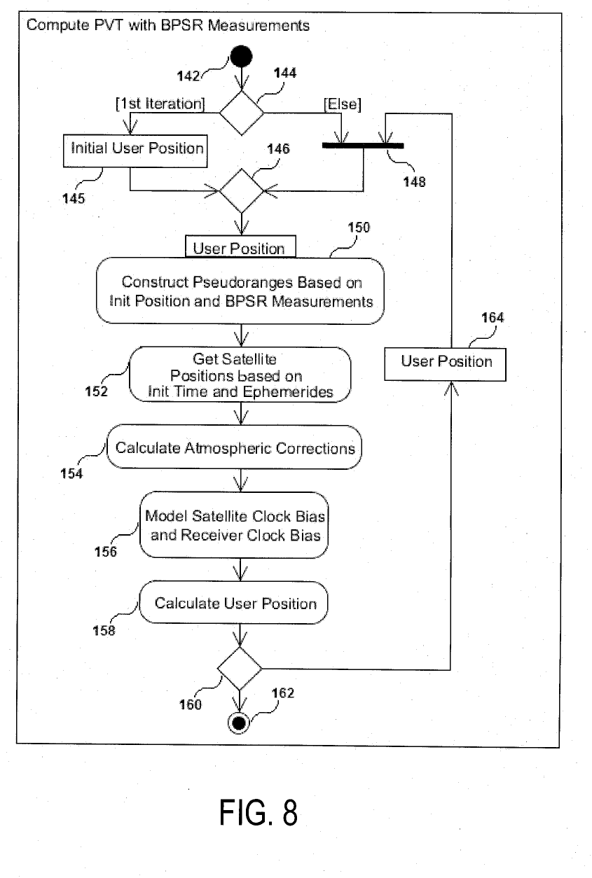

Action 222 can be expanded into another UML activity diagram, as illustrated in FIG. 8. The process begins at the Start-Point 236, and enters the Decision 238. For the first iteration, it will use the initial user position, as shown as Object 240, and move into the Merge 244, then starts to process the BPSR measurements together with the receiver position as shown at 246. As shown at 248, the satellite positions, which are important for the following modelling, may be computed based on the initial time and ephemerides. The next step is to calculate atmospheric corrections 250. The next step is to model Satellite Clock Bias and Receiver Clock Bias 252, and calculate receiver position 254. Once position is calculated, the process will reach the End-Point 260, so the engine that called the sub-process may go on. At the same time, the intermediate user position 258 will be sent to Join 242, and wait for the next call of the action 222 to arrive. Once 222 is called again, it will take the intermediate user position 258 as the user position, and then starts to process the BPSR measurements together with the user position as shown at 246, and the process goes on.

Assuming the pseudorange measurement ρⁱ (integer and fractional part) is known, and the initial time tag is also known, then the basic observation equation for the pseudorange can be represented as:

ρⁱ=∥rᵢ−rᵤ∥+c*Δtᵤ−c*Δtⁱ+ΔI+ΔT+ΔM+Sε (17)

where ρⁱ is the pseudorange of the i^{th} satellite, rᵢ is the i^{th} satellite location, is the receiver location, Δtᵤ is the receiver clock bias, Δtⁱ is the satellite clock error, ΔI is the Ionospheric delay, ΔT is the Tropospheric delay, ΔM is the Multipath, and E is the measurement noise and usually treated as white noise.

When the Ephemeris or Almanac is known, the satellite location and the satellite clock error can be determined based on the time tag. However, when the time tag is unknown, or is known but has significant errors compared to the true GPS time, it may cause errors in determining the satellite location and the satellite clock error, and generate errors in the pseudorange measurements. Thus it may be necessary to take this time tag error into account.

ρⁱ=∥rᵢ−rᵤ∥+c*Δtᵤ−c*Δtⁱ+ΔI+ΔT+ΔM+S(eₜ,i)+ε (18)

where S(eₜ, i) represents the error of the pseudorange measurements that is caused by the time tag error, and is a non-linear function of the time tag error eₜ. It may be different for every satellite since their ephemeris/almanac parameters are different.

Assuming that the ionospheric delay, tropospheric delay, and multipath are negligible, known, or can be determined, rᵤ, eₜ and Δtᵤ can be estimated. Both rᵢ and Δtⁱ can be determined by the ephemeris and eₜ, and, therefore, may not require estimation. Equation (18) can therefore be rewritten as:

ρⁱ−ΔI−ΔT−ΔM+c*Δtⁱ+ε=∥rᵢ−rᵤ∥+c*Δtᵤ−S(eᵢ,t) (19)

The right side of equation (19) includes the following variables that need to be estimated: the receiver position rᵤ (X/Y/Z, or Latitude/Longitude/Height), the receiver clock bias Δtᵤ, and the error of the initial time tag eₜ. By representing the estimated variables with X, the right side of (19) can be represented as a function of X, as follows:

$${G}_{i} ( X ) = ‖ {r}_{i} - {r}_{u} ‖ + c * Δ {t}_{u} + S ( {e}_{t} , i ) \\ G ( X ) = [ \begin{matrix}{G}_{1} ( X ) \\ {G}_{2} ( X ) \\ ⋮\end{matrix} ] \qquad ( 20 )$$

As (20) is a non-linear equation, it can be approximated around X₀ by Taylor series

G(X)≈G(X₀)+G′(X|X₀)*dX (21)

Assuming S(eₜ, i), its derivatives over eₜ, or its simplified linear form over eₜ may be available, for example, by numerical analysis, G′(X|X₀) will be derivable. Thus Equation (19) can then be rewritten into a standard form of linear least-square equation:

$$\begin{matrix}y = [ \begin{matrix}{y}_{1} \\ {y}_{2} \\ ⋮\end{matrix} ] = Ax \\ with & ( 22 ) \\ {y}_{i} = {ρ}^{i} - Δ I - Δ T - Δ M + c * Δ {t}^{i} {\vert}_{{X}_{0}} - G ( {X}_{0} ) & ( 23 ) \\ A = {G}^{′} ( X \vert {X}_{0} ) & ( 24 ) \\ x = dX = X - {X}_{0} & ( 25 )\end{matrix}$$

Furthermore, the quality of the BPSR measurements may be affected by factors such as the geometry of the satellites and their movements, atmosphere activities, interferences, multipath and the receiver hardware. In turn, the quality of the BPSR measurements may affect the performance of the Fine Search Utility and the accuracy of solutions. By introducing noisy observables into the weighted least square algorithm without assigning proper weights to them the accuracy of the solutions may degrade.

The Fine Search Utility may assess the quality of the BPSR measurements and assign them proper weights. The Fine Search Utility may assign weights to the BPSR measurements using the variance-covariance matrix R of the measurement noise of the BPSR measurements.

If the variance-covariance matrix R of measurement noise is unknown, the estimation of x can be represented as:

\hat{x}=(A^{T}*A)⁻¹*A^{T}*y (26)

If the variance-covariance matrix R of the measurement noise is available, according to the definition of the Best Linear Unbiased Estimator (BLUE), the estimation of x can be represented as:

\hat{x}=(A^{T}*R⁻¹*A)⁻¹*A^{T}*R⁻¹*y (27)

With no less than five qualified BPSR measurements available, the Fine Search Utility may generate the solutions at accuracy typically between a few meters and a few tens of meters (3 dimension), and may be used for both low and high dynamic applications. The estimation and compensation for the time tag error may loose the initial time requirement up to a few tens of minutes. Such a loose requirement on the initial time accuracy may enable the RF circuitry to continue to work for years without calibration or alignment on their clock.

6.2 Using BPSR Measurements of Multiple Epochs

There may be cases when the number of the BPSR measurements and/or the number of general observables is less than the number of system variables/states. The Fast TTFF engine may use measurements from adjacent epochs to generate valid position solutions. For example, the BPSR measurements of the current epoch can be used together with the BPSR measurements of one or more of the past epochs to constitute observations and equations and solve the states. Since independent BPSR measurements may be obtained almost every 1 ms, the time tag difference between measurements are typically no more than 1 or 2 ms. Therefore, it can be assumed that the variables of the system X, Y, Z, Δtᵤ and eₜ, which represent receiver position, receiver clock bias (also called the offset of the receiver clock from system time) and the time tag error, are virtually unchanged during this short period. However, since the satellites can move several meters within 1 ms, the satellite position may be measured by its own time tag.

For example, if i is the BPSR measurements at epoch t₁ and j is the BPSR measurements at epoch t₂, then equation (20) can be rewritten as:

G_{i,t1}(X)=∥rᵢ|ₜ₁−rᵤ|ₜ₁∥+c*Δtᵤ|ₜ₁+S(eₜ|ₜ₁,i) (28)

G_{j,t2}(X)=∥rⱼ|ₜ₂−rᵤ|ₜ₂∥+c*Δtᵤ|ₜ₂+S(eₜ|ₜ₂,j) (29)

Equations (28) and (29) can represent either the same satellite (i=j) or two different satellites (i≠j).

Assuming the receiver position, the receiver clock bias, and the time tag error of t₁ are virtually the same as those of t₂, (30) can be derived from (28) and (29).

G_{ij,t12}(X)=∥rᵢ|ₜ₁−rᵤ∥−∥rⱼ|ₜ₂−rᵤ∥+S(eₜ|ₜ₁,i)−S(eₜ|ₜ₂,j) (30)

Now rᵤ and eₜ, may be the states to be estimated based on (30). Alternatively, rᵤ, Δtᵤ and eₜ, can be estimated based on (28) and (29). As long as the assumptions of (i) the difference of the receiver position between t₁ and t₂, (ii) the difference of the receiver clock bias between t₁ and t₂ and (iii) the difference of the time tag error between t₁ and t₂ are valid; the observables can be increased by introducing more BPSR measurements at different epochs. Thus the states may be estimated.

### 7. Quality Control Based on Independent Measurements and Solutions

Statistically, blunders are observations that cannot be considered as belonging to the same samples from the distribution in question. They could not therefore be used together with other observables, and should be detected and removed out to control the data quality.

The present invention requires as little as 2 ms, of I/Q samples to generate valid raw measurements. It is therefore possible to obtain 500 Hz of independent raw measurements and positioning solutions. As a result, this ultra high rate of available measurements and solutions can be used to filter out noise, assess the significance of the receiver drift error, the receiver clock bias and other type of clock errors, assess the observation data quality, calculate the mean and the variance-covariance matrix of measurement noise, detect and reject the blunders, fill the gap of the blunders, and smooth the positioning results.

A number of techniques may be used to assess the data quality based on the independent raw measurements. For example, a blunder series can be built for each epoch based on the Doppler Frequency Shift measurements. For example, to get the blunder value of current epoch, a common set of satellite signals that appear in both the current epoch and the next epoch may be selected. The Doppler Frequency Shift measurements of the set at the current epoch can be added to obtain the first sum, and then those at the next epoch can be added to obtain the second sum. The first sum may be subtracted from the second sum to get the blunder value of the current epoch. By studying the blunder series, such as its statistical properties, its zero, first and second order differentials, the significance of the clock drift error may be assessed. Similarly, the significance of the receiver clock bias and other type of clock errors may be assessed as well based on the independent BPSR measurements. The error may consequently be modeled. The error may also be updated periodically or continuously.

By assuming that the raw measurements have a normal distribution, and its mean value and variance-covariance matrix can be obtained, the blunders can be detected, usually by Chi-squares goodness of fit test or Kolmogorov-Smirnov goodness of fit test, and then identified.

Similarly, to assess the significance of the measurement errors of each satellite signal, a blunder series can be built by subtracting the raw measurements of this satellite signal at the current epoch from the raw measurements of this satellite signal at the next epoch. The error may consequently be modeled. The error may also be updated periodically or continuously.

As previously mentioned, there may be many factors affecting the quality of the raw measurements and, therefore, the performance of the Fast TTFF engine. Some errors may be difficult or impossible to model, predict, or detect based on the raw measurements. A number of techniques may be used to assess the quality of the positioning results based on the independent positioning solutions.

For example, all the available positioning solutions may be put into a series in a time window and the blunders may be detected based on the statistical significance. The significance level (also known as the critical p-value) may be determined by the noise level, the receiver dynamic, the window size, and/or the sampling rate. The quality of positioning solutions may be time-variant, so the Fast TTFF engine may perform quality control continuously. Once a blunder is detected, it may be rejected from the series of solutions, and the gap of the blunders can be filled by different methods. For example, the blunder can be replaced by simply copying the value of its good neighbour, or by interpolating, or by smoothing, or by predicting, as long as it meets the accuracy requirement of the applications. The availability of the high-speed output rate enables many new ways to process positioning solutions.

Thus, in an aspect, there is provided a system for determining position of a global navigation satellite system (GNSS) receiver having a fast time to first fix (TTFF), the system comprising: a parameter obtaining means for obtaining almanac/ephemeris parameters of one or more GNSS satellites; a fast TTFF engine linkable to a signal interface that is operable to provide in-phase and/or quadrature (I/Q) samples from a GNSS antenna, and a clock obtaining means for obtaining a clock for estimating a GNSS time tag; wherein the fast TTFF engine comprises: a measurement generation utility to compute the Doppler frequency shift and the code phase of the one or more GNSS satellites based on the I/Q samples; a coarse search utility to determine a coarse position based on Doppler frequency shift measurements, the satellite parameters, and the time tag; and a fine search utility to determine position based on the coarse position, code phase measurements, the satellite parameters, and the time tag.

In an embodiment, the fast TTFF engine estimates the time tag by estimating and compensating values of a time tag error variable and a clock drift error variable to model the error between the clock and the time tag.

In another embodiment, the signal interface obtains a GNSS signal from one or more of a GNSS antenna, a tracking loop of a GNSS receiver, a GNSS RFIC, a GNSS RF front-end or a direct sampled analog-to-digital converter via a direct or wireless network.

In another embodiment, the measurement generation utility computes Doppler frequency shift using one or more computation techniques such as parallel frequency space search acquisition.

In another embodiment, the measurement generation utility computes code phase using computation techniques such as parallel code phase search acquisition.

In another embodiment, the measurement generation utility computes position from 2*N ms of I/Q samples, where N is an integer no less than 1, and the I/Q samples are divided evenly into two equal sets of N ms to support the Doppler frequency shift measurements utilizing techniques such as parallel frequency search acquisition, and the code phase measurement.

In another embodiment, the fast TTFF engine includes or is linked to a storage means for storing I/Q samples, wherein the fast TTFF engine can determine one or more of position, velocity and time using stored I/Q samples.

In another embodiment, the parameter obtaining means is linked to a web server so as to obtain almanac/ephemeris parameters.

In another embodiment, the parameter obtaining means implements a predictive satellite almanac/ephemeris algorithm to obtain almanac/ephemeris parameters.

In another embodiment, the parameter obtaining means obtains almanac/ephemeris parameters from a GNSS receiver.

In another aspect, there is provided a method of determining position of a global navigation satellite system (GNSS) receiver having a fast time to first fix (TTFF) utilizing a fast TTFF engine, the method comprising: obtaining almanac/ephemeris parameters of one or more GNSS satellites from a parameter obtaining means; obtaining in-phase and/or quadrature (I/Q) samples via a signal interface from one or more a GNSS antenna, and a clock obtaining means for obtaining a clock for estimating a GNSS time tag; computing a Doppler frequency shift and the code phase of the one or more GNSS satellites based on the I/Q samples utilizing a measurement generation utility; determining a coarse position based on Doppler frequency shift measurements, the satellite parameters, and the time tag utilizing a coarse search utility; and determining position based on the coarse position, code phase measurements, the satellite parameters, and the time tag utilizing a fine search utility.

In an embodiment, the method further comprises estimating the time tag by estimating and compensating values of a time tag error variable and a clock drift error variable to model the error between the clock and the time tag.

In another embodiment, the method further comprises obtaining a GNSS signal from one or more of a GNSS antenna, a tracking loop of a GNSS receiver, a GNSS RFIC, a GNSS RF front-end or a direct sampled analog-to-digital converter via a direct or wireless network.

In another embodiment, the method further comprises computing utilizing a measurement generation utility the Doppler frequency shift using one or more computation techniques such as parallel frequency space search acquisition.

In another embodiment, the method further comprises computing utilizing the measurement generation utility the code phase using one or more computation techniques such as parallel code phase search acquisition.

In another embodiment, the method further comprises computing utilizing the measurement generation utility a position from 2*N ms of I/Q samples, where N is an integer no less than 1, and the 1/Q samples are divided evenly into two equal sets of N ms to support the Doppler frequency shift measurements utilizing techniques such as parallel frequency search acquisition, and the code phase measurement.

In an embodiment, the Fast TTFF engine includes or is linked to a storage means for storing I/Q samples, and the method further comprises determining fast TTFF engine can determine one or more of position, velocity and time using stored I/Q samples.

In an embodiment, the method further comprises linking the parameter obtaining means to a web server so as to obtain almanac/ephemeris parameters.

In an embodiment, the method further comprises implementing a predictive satellite almanac/ephemeris algorithm to obtain almanac/ephemeris parameters.

In an embodiment, the method further comprises almanac/ephemeris parameters from a GNSS receiver.

In another aspect, there is provided a non-volatile computer readable media storing computer code that when loaded into a system for determining position of a global navigation satellite system (GNSS) receiver having a fast time to first fix (TTFF) adapts the system to perform one of the above methods.

While the above description provides illustrative examples of systems and methods in accordance with one or more embodiments, it will be appreciated that other embodiments may be within the scope of the present description and the below claims as interpreted by one of skill in the art.

1. A system for determining position of a global navigation satellite system (GNSS) receiver having a fast time to first fix (TTFF), the system comprising:
a parameter obtaining means for obtaining almanac/ephemeris parameters of one or more GNSS satellites;
a fast TTFF engine linkable to a signal interface that is operable to provide in-phase and/or quadrature (I/Q) samples from a GNSS antenna, and a clock obtaining means for obtaining a clock for estimating a GNSS time tag;
wherein the fast TTFF engine comprises:
a measurement generation utility to compute the Doppler frequency shift and the code phase of the one or more GNSS satellites based on the I/Q samples;
a coarse search utility to determine a coarse position based on Doppler frequency shift measurements, the satellite parameters, and the time tag; and
a fine search utility to determine position based on the coarse position, code phase measurements, the satellite parameters, and the time tag.

2. The system of claim 1, wherein the fast TTFF engine estimates the time tag by estimating and compensating values of a time tag error variable and a clock drift error variable to model the error between the clock and the time tag.

3. The system of claim 1, wherein the signal interface obtains a GNSS signal from one or more of a GNSS antenna, a tracking loop of a GNSS receiver, a GNSS RFIC, a GNSS RF front-end or a direct sampled analog-to-digital converter via a direct or wireless network.

4. The system of claim 1, wherein the measurement generation utility computes Doppler frequency shift using one or more computation techniques such as parallel frequency space search acquisition.

5. The system of claim 1, wherein the measurement generation utility computes code phase using computation techniques such as parallel code phase search acquisition.

6. The system of claim 1, wherein the measurement generation utility computes position from 2*N ms of I/Q samples, where N is an integer no less than 1, and the I/Q samples are divided evenly into two equal sets of N ms to support the Doppler frequency shift measurements utilizing techniques such as parallel frequency search acquisition, and the code phase measurement.

7. The system of claim 1, wherein the fast TTFF engine includes or is linked to a storage means for storing I/Q samples, wherein the fast TTFF engine can determine one or more of position, velocity and time using stored I/Q samples.

8. The system of claim 1, wherein the parameter obtaining means is linked to a web server so as to obtain almanac/ephemeris parameters.

9. The system of claim 1, wherein the parameter obtaining means implements a predictive satellite almanac/ephemeris algorithm to obtain almanac/ephemeris parameters.

10. The system of claim 1, wherein the parameter obtaining means obtains almanac/ephemeris parameters from a GNSS receiver.

11. A method of determining position of a global navigation satellite system (GNSS) receiver having a fast time to first fix (TTFF) utilizing a fast TTFF engine, the method comprising:
obtaining almanac/ephemeris parameters of one or more GNSS satellites from a parameter obtaining means;
obtaining in-phase and/or quadrature (I/Q) samples via a signal interface from one or more a GNSS antenna, and a clock obtaining means for obtaining a clock for estimating a GNSS time tag;
computing a Doppler frequency shift and the code phase of the one or more GNSS satellites based on the I/Q samples utilizing a measurement generation utility;
determining a coarse position based on Doppler frequency shift measurements, the satellite parameters, and the time tag utilizing a coarse search utility; and
determining position based on the coarse position, code phase measurements, the satellite parameters, and the time tag utilizing a fine search utility.

12. The method of claim 11, further comprising estimating the time tag by estimating and compensating values of a time tag error variable and a clock drift error variable to model the error between the clock and the time tag.

13. The method of claim 11, further comprising obtaining a GNSS signal from one or more of a GNSS antenna, a tracking loop of a GNSS receiver, a GNSS RFIC, a GNSS RF front-end or a direct sampled analog-to-digital converter via a direct or wireless network.

14. The method of claim 11, further comprising computing utilizing a measurement generation utility the Doppler frequency shift using one or more computation techniques such as parallel frequency space search acquisition.

15. The method of claim 11, further comprising computing utilizing the measurement generation utility the code phase using one or more computation techniques such as parallel code phase search acquisition.

16. The method of claim 11, further comprising computing utilizing the measurement generation utility a position from 2*N ms of I/Q samples, where N is an integer no less than 1, and the I/Q samples are divided evenly into two equal sets of N ms to support the Doppler frequency shift measurements utilizing techniques such as parallel frequency search acquisition, and the code phase measurement.

17. The method of claim 11, wherein the Fast TTFF engine includes or is linked to a storage means for storing I/Q samples, and the method further comprises determining fast TTFF engine can determine one or more of position, velocity and time using stored I/Q samples.

18. The method of claim 11, further comprising linking the parameter obtaining means to a web server so as to obtain almanac/ephemeris parameters.

19. The method of claim 11, further comprising implementing a predictive satellite almanac/ephemeris algorithm to obtain almanac/ephemeris parameters.

20. The method of claim 11, further comprising almanac/ephemeris parameters from a GNSS receiver.

21. A non-volatile computer readable media storing computer code that when loaded into a system for determining position of a global navigation satellite system (GNSS) receiver having a fast time to first fix (TTFF) adapts the system to perform one of the methods of claims 10 to 20.
